(19) United States
(12) Patent Application Publication
(10) Pub. No.: US 2026/0364618 A1
(43) Pub. Date: Nov. 19, 2026

(54) DISPENSING DEVICE FOR DISPENSING A LIQUID JET SURROUNDED BY AN AIR FLOW IN THE FORM OF A JACKET

(71) Applicant: Alfred Kärcher SE & Co. KG, Winnenden (DE)

(72) Inventors: Patrick FOLTYN, Winnenden (DE); Tobias GELTZ, Winnenden (DE); Florian SEYBOLD, Winnenden (DE)

(21) Appl. No.: 19/727,827

(22) Filed: Jul. 1, 2026

Related U.S. Application Data
(63) Continuation of application No. PCT/EP2024/084228, filed on Dec. 2, 2024.

(30) Foreign Application Priority Data
Jan. 24, 2024 (DE) 10 2024 102 070.9

(51) Int. Cl. B05B 7/04; B05B 1/04; B05B 12/18

(52) U.S. Cl. CPC B05B 7/0416; B05B 1/044; B05B 12/18

(57) ABSTRACT

The invention relates to a dispensing device for dispensing a liquid jet that is surrounded by an air flow in the form of a jacket and widens in the shape of a fan in a jet plane. The dispensing device includes a jet producing part with a flat jet nozzle for producing the liquid jet and an air envelope part for enveloping the liquid jet with an air flow. The air envelope part includes a receiving portion for receiving the liquid jet and a dispensing portion for dispensing the liquid jet and the air flow enveloping it. The distance of an outlet opening from a nozzle exit opening of the flat jet nozzle is at least 0.16 times a predetermined percentage increase in the cleaning width plus a fixed value of 9 cm.

### CROSS-REFERENCE TO RELATED APPLICATIONS

This application is a continuation of international application number PCT/EP2024/084228, filed on Dec. 2, 2024, and claims the benefit of German application number 10 2024 102 070.9, filed on Jan. 24, 2024, which are incorporated herein by reference in their entirety and for all purposes.

### BACKGROUND OF THE INVENTION

The invention relates to a dispensing device for dispensing a liquid jet that is surrounded by an air flow in the form of a jacket and widens in the shape of a fan in a jet plane, wherein the dispensing device comprises a jet producing part having a flat jet nozzle for producing the liquid jet and an air envelope part for enveloping the liquid jet with an air flow, wherein the air envelope part comprises a through-channel, which comprises a receiving portion for receiving the liquid jet and a dispensing portion for dispensing the liquid jet and the air flow enveloping it, wherein the receiving portion is in flow connection with at least one air intake opening of the dispensing device and the dispensing portion extends up to an outlet opening and widens in the shape of a fan in the jet plane.

Jet producing parts with a flat jet nozzle for producing a liquid jet that widens in the shape of a fan in a jet plane are used, for example, as accessories for pressure cleaning devices, in particular for high-pressure cleaning devices, in order to be able to pass over a surface to be cleaned with a fanned-out liquid jet. The jet producing parts can be designed, for example, as a jet pipe with an integrated flat jet nozzle. Pressurized water may be used as liquid, for example. Flat jet nozzles of that kind are known from WO 2014/090333 A1.

The fan-shaped liquid jet exiting the flat jet nozzle is subject to an interaction with the ambient air on its path to the surface to be cleaned. This results in the liquid jet being decelerated and losing compactness, thus negatively impacting the achievable cleaning intensity. In order to counteract this effect, a dispensing device is proposed in JP 2004223409 A, in which, in addition to a jet producing part in the form of a feed pipe, which carries a flat jet nozzle at its free end, an air envelope part for enveloping the liquid jet with an air flow is used, the air flow surrounding the liquid jet provided by the flat jet nozzle in the form of a jacket. The air envelope part comprises a through-channel with a receiving portion and a dispensing portion. The receiving portion receives the liquid jet exiting the flat jet nozzle and is in flow connection with a plurality of air intake openings. The dispensing portion extends from the receiving portion up to an outlet opening of the air envelope part and widens in the jet plane with increasing proximity to the outlet opening. Under the effect of the liquid jet, air is drawn into the through-channel via the air intake openings, forming an air jacket that envelops the liquid jet and is discharged together with the liquid jet via the outlet opening. The air jacket surrounding the liquid jet widening in the shape of a fan reduces the interaction of the liquid jet with the ambient air.

The dispensing device makes it possible, through the use of the air envelope part, when guiding the liquid jet along a surface to be cleaned, to clean a wider surface region with the same cleaning intensity than is the case when using the flat jet nozzle without the air envelope part. This means that a larger cleaning width can be achieved on the surface to be cleaned. It would be helpful if the dispensing device could be configured in such a way that a predetermined percentage increase in the cleaning width is achievable compared with the cleaning width that can be achieved with equal cleaning intensity using the same flat jet nozzle without the use of the air envelope part.

In accordance with an embodiment of the invention, a dispensing device of the generic type is further developed in such a way that a predetermined percentage increase in the cleaning width is achievable compared with the cleaning width that can be achieved at an equal cleaning intensity with the same flat jet nozzle without the air envelope part.

### SUMMARY OF THE INVENTION

In accordance with an embodiment of the invention, in a dispensing device of the kind stated at the outset, provision is made that the distance of the outlet opening of the air envelope part from the nozzle exit opening of the flat jet nozzle measured in centimeters is at least 0.16 times a predetermined percentage increase in the cleaning width plus a fixed value of 9 cm, wherein the percentage increase in the cleaning width refers to the cleaning width that is achievable at the same cleaning intensity with the flat jet nozzle without the air envelope part. “Cleaning width” is understood to mean the width of the surface strip of a surface to be cleaned in which a predetermined cleaning intensity is achieved when the liquid jet is guided once along the surface at a uniform speed with the liquid jet oriented perpendicularly to the surface, wherein the width of the surface strip is measured in the jet plane of the liquid jet. The predetermined cleaning intensity can, for example, be a predetermined percentage removal of a surface coating of a surface to be cleaned. For example, the liquid jet can be guided at a relative speed of 10 cm/s along the surface to be cleaned, with the liquid jet oriented perpendicularly to the surface. The predetermined percentage removal can, for example, be between 20% and 100%, in particular 50%, of the surface coating. The surface to be cleaned may, for example, be a plastic sheet of extruded polystyrene coated with dispersion paint. When the plastic plate coated with dispersion paint is acted upon with the liquid jet, the dispersion paint can thus be at least partially removed. When using black dispersion paint applied to a white plastic sheet made of extruded polystyrene, the cleaning intensity achievable by means of the liquid jet is shown in a lightening of the surface of the plastic sheet acted upon with the liquid jet. When the liquid jet is moved at a uniform speed relative to the plastic plate and directed perpendicularly to the plastic plate, a strip-shaped, lightened surface region is formed. The width of the lightened surface region represents the achievable cleaning width. When using the dispensing device in accordance with the invention, said width is greater than the width of the strip-shaped surface region with the same lightening that is achievable under the same conditions by means of the flat jet nozzle without the use of the air envelope part. The desired percentage increase in the cleaning width determines the distance of the outlet opening of the air envelope part from the nozzle exit opening of the flat jet nozzle that is required for this percentage increase. The distance of the outlet opening of the air envelope part from the nozzle exit opening of the flat jet nozzle required for the desired percentage increase in the cleaning width is namely at least 0.16 times the desired percentage increase in the cleaning width plus a fixed value of 9 cm.

The invention incorporates the knowledge that a concrete linear relationship exists between a predetermined percentage increase in the cleaning width and the distance of the outlet opening of the air envelope part from the nozzle exit opening of the flat jet nozzle required for this increase. At least for percentage increases in the range of 20% to 75%, a predetermined percentage increase in the cleaning width can be achieved by a distance of the outlet opening of the air envelope part from the nozzle exit opening of the flat jet nozzle that, measured in centimeters, is at least 0.16 times the specified percentage increase in the cleaning width plus a fixed value of 9 cm. It should be noted that the distance may vary by ±5% due to manufacturing tolerances and metrological reasons. As already mentioned, the percentage increase in the cleaning width refers to the cleaning width that is achievable at the same cleaning intensity with the same flat jet nozzle without the air envelope part.

If, for example, a cleaning width increase of 50% is to be achieved by means of the dispensing device in accordance with the invention when uniformly guiding the liquid jet at a relative speed of 10 cm/s along the surface to be cleaned with the liquid jet oriented perpendicularly to the surface compared to the cleaning width that is achievable at the same cleaning intensity with the flat jet nozzle of the dispensing device without the air envelope part, it is thus necessary to configure the dispensing device in such a way that the distance of the outlet opening of the air envelope part from the nozzle exit opening of the flat jet nozzle is at least 17 cm.

Preferably, the predetermined percentage increase in the cleaning width is 20% to 75%.

It is advantageous if the distance of the outlet opening of the air envelope part from the nozzle exit opening of the flat jet nozzle is at most 0.16 times the predetermined percentage increase in the cleaning width plus a further fixed value of at most 13.5 cm, in particular 11 cm. As a result, impairments to the maximum achievable cleaning intensity and the handling of the dispensing device can be kept to a minimum.

In an advantageous embodiment of the dispensing device in accordance with the invention, the dispensing portion widening in the shape of a fan in the jet plane has an opening angle of 20° to 30°, in particular an opening angle of 25°, in the jet plane. Such opening angles allow the liquid jet to be particularly effectively enveloped with air within the dispensing portion in order to protect the liquid jet from disturbances.

The dispensing device in accordance with the invention is preferably set up to dispense liquid at a pressure of 10 bar to 300 bar. The liquid pressure, in particular, may be 70 bar to 250 bar.

It is favorable if the dispensing device is set up to dispense liquid with a volume flow of 300 l/h to 3,000 l/h, in particular with a volume flow of 300 l/h to 1,300 l/h, particularly preferably 400 l/h to 500 l/h, for example 490 l/h.

In a preferred embodiment of the dispensing device in accordance with the invention, the flow cross-section of the receiving portion of the through-channel decreases in the direction of the dispensing portion. This allows the air entering the receiving portion via the at least one air intake opening to be accelerated.

It is advantageous if the dispensing portion directly adjoins the smallest flow cross-section of the receiving portion in the flow direction of the liquid. The smallest flow cross-section of the receiving portion thus forms a constriction point of the through-channel, which is directly adjoined by the dispensing portion that widens in the jet plane. This increases the intake of air into the receiving channel.

In order to keep flow losses of the sucked-in air particularly low, it is advantageous if the dispensing portion adjoins the receiving portion with a continuous tangent.

In a preferred embodiment of the invention, the smallest flow cross-section of the receiving portion is arranged at a distance of 3 mm to 70 mm from the nozzle exit opening of the flat jet nozzle, in particular at a distance of 20 mm to 40 mm, for example 29 mm.

The height of the dispensing portion perpendicular to the jet plane is favorably 1 mm to 6 mm. It has been shown that as a result, the liquid jet widening in the shape of a fan in the jet plane is subject to only minor impairments.

The height of the dispensing portion perpendicular to the jet plane may be constant over the entire length of the dispensing portion. Alternatively, provision may be made that the height of the dispensing portion perpendicular to the jet plane decreases at least in a longitudinal region with increasing proximity to the outlet opening of the air envelope part. Provision may be made, for example, that the dispensing portion has a height of 6 mm in its inlet region, the height decreasing to 1 mm up to the outlet opening of the air envelope part.

The width of the outlet opening of the air envelope part is advantageously 60 mm to 120 mm in the jet plane.

In a preferred embodiment of the dispensing device in accordance with the invention, the flat jet nozzle is set up to dispense a liquid jet widening in the shape of fan under a jet angle of 20° to 30°, in particular under a jet angle of 23° to 27°, for example 25°.

The subsequent description of an advantageous embodiment of the invention serves in conjunction with the drawing for further explanation. In the drawings:

### BRIEF DESCRIPTION OF THE DRAWINGS

FIG. 1 shows a perspective depiction of a dispensing device for dispensing a liquid jet that is surrounded by an air flow in the shape of a jacket and widens in the shape of a fan in a jet plane, said dispensing device comprising a jet producing part and an air envelope part;

FIG. 2 shows a perspective depiction of the air envelope part of the dispensing device from FIG. 1 obliquely from the front;

FIG. 3 shows a perspective section view of the air envelope part of the dispensing device from FIG. 1;

FIG. 4 shows a partial section view of the dispensing device from FIG. 1 in the jet plane of the liquid jet;

FIG. 5 shows a graphical illustration of the distance of an outlet opening of the air envelope part from the nozzle exit opening of a flat jet nozzle of the jet producing part required to achieve a predeterminable percentage increase in a cleaning width.

### DETAILED DESCRIPTION OF THE INVENTION

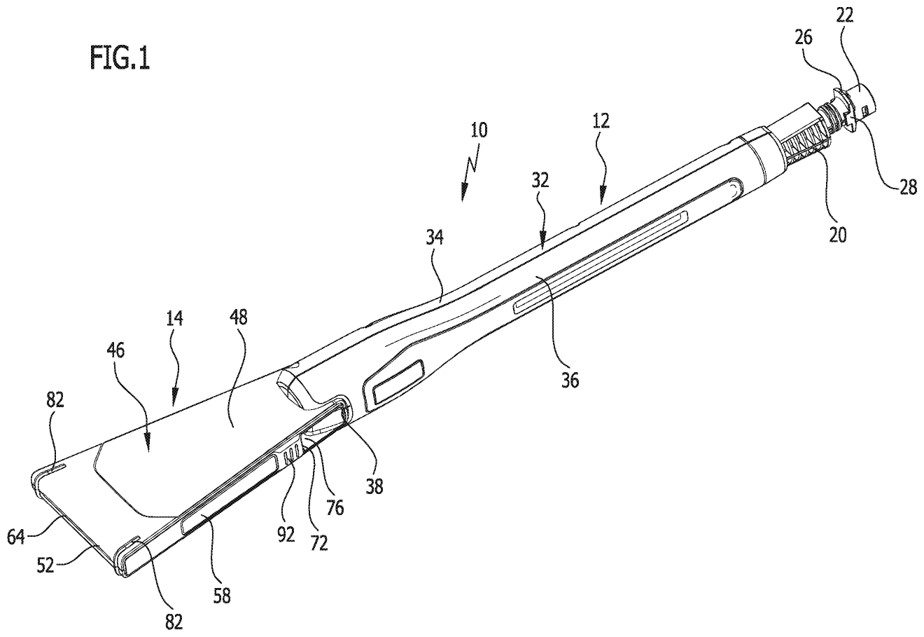

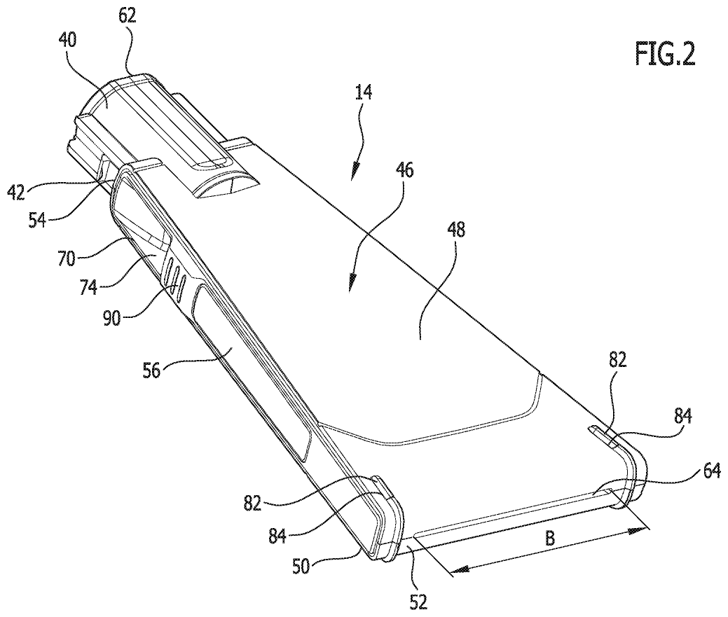

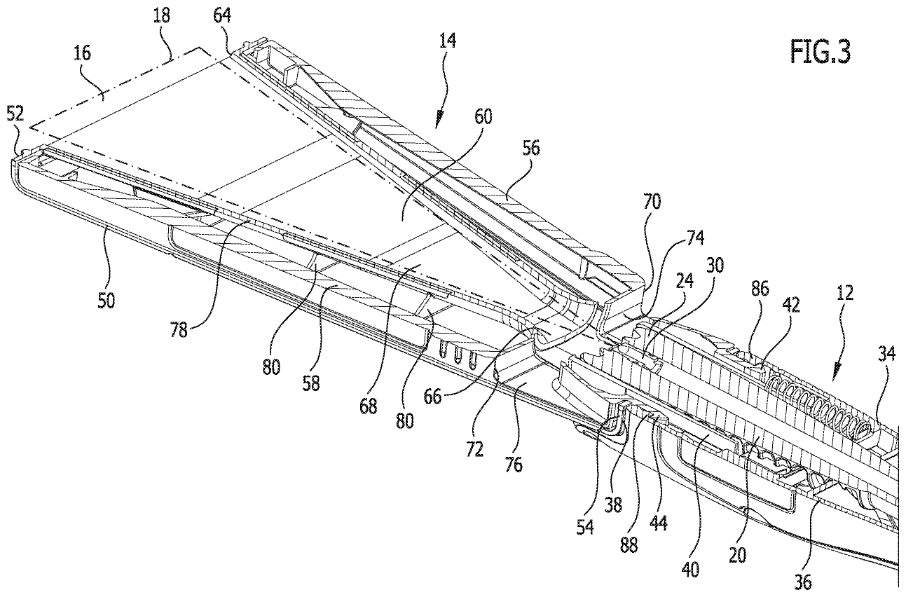

Depicted schematically as an example in FIGS. 1 to 4 is an advantageous embodiment of a dispensing device in accordance with the invention for dispensing a liquid jet that is surrounded by an air flow in the shape of a jacket and widens in the shape of a fan in a jet plane, said dispensing device being denoted as a whole with the reference numeral 10. The dispensing device 10 comprises a jet producing part 12 and an air envelope part 14, which are connectable to one another in a pluggable manner and latchable to one another in a predetermined rotational position. By means of the jet producing part 12, a liquid jet 18 that widens in the shape of a fan in a jet plane 16 can be produced, which can be enveloped by a jacket-shaped air flow by means of the air envelope part 14. The jet plane 16 and the liquid jet 18 are depicted with dash-dotted lines in FIG. 3.

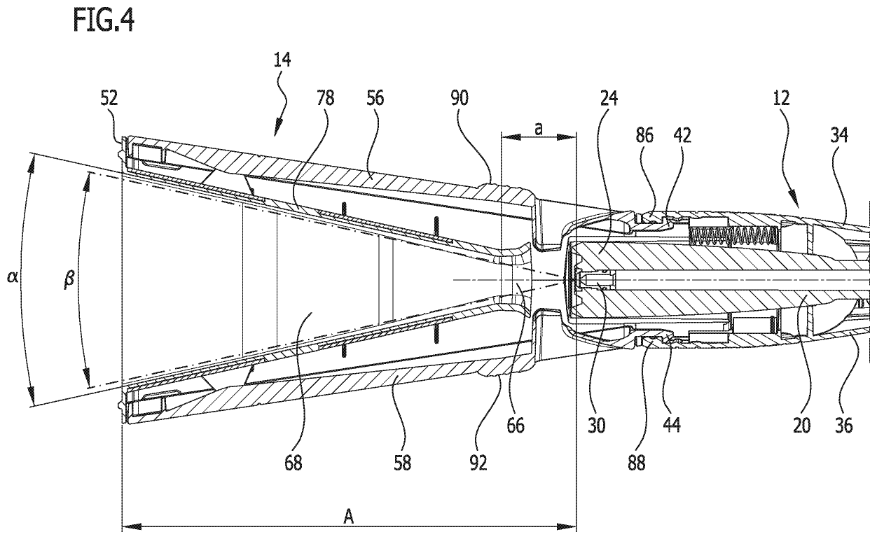

As is clear in FIGS. 1 and 4, the jet producing part 12 comprises a jet pipe 20 with a first end region 22 and a second end region 24. At the first end region 22, a connecting element 26 is arranged, by means of which the jet producing part 12 can be releasably connected to liquid supply part that is known per se and therefore not shown in the drawing for achieving a better overview. In the embodiment depicted, the connecting element 26 is configured as a bayonet connecting member 28. For example, a spray gun can be used as a liquid supply part, which is in flow connection with a high-pressure cleaning device by way of a pressure hose.

At the second end portion 24 of the jet pipe 20, a flat jet nozzle 30 is arranged in a rotationally-fixed manner, which is accommodated by the jet pipe 20 in a positive-locking manner. By way of the liquid supply part not depicted in the drawing, pressurized liquid, in particular a cleaning liquid, can be supplied to the jet producing part 12, which can be dispensed by means of the flat jet nozzle 30 in the form of a liquid jet 18 widening in the shape of a fan in the jet plane 16. Flat jet nozzles of that kind are known to the person skilled in the art, for example from WO 2014/090333 A1.

The jet pipe 20 is surrounded by a housing shell 32, which is formed by two half-shells that can be screwed together and which on its front side 38 facing toward the air envelope part 14 forms a receptacle, into which an end portion of the air envelope part 14 pointing toward the jet producing part 12 is able to be inserted. The end portion is configured in the form of a sleeve 40 and on its outer side comprises two diametrically opposed latching hooks 42, 44, by means of which the jet producing part 12 is able to be releasably latched to the air envelope part 14. This is described in more detail below.

The air envelope part 14 comprises a housing 46, which adjoins the sleeve 40 in the direction pointing away from the jet producing part 12, and comprises a top wall 48, a base wall 50, and an end wall 52 facing away from the jet producing part 12 and a rear wall 54 facing toward the jet producing part 12, as well as two elastically deformable side walls 56, 58 arranged opposite one another. The side walls 56, 58 are arranged between the top wall 48 and the base wall 50 and each extend from the end wall 52 to the rear wall 54. The side walls 56, 58 are each adjoined in the direction toward the jet producing part 12 by a respective latching hook 42 and 44, wherein the latching hooks 42, 44 engage through the rear wall 54. The sleeve 40 is molded onto the rear wall 54. The housing 46 of the air envelope part 14 surrounds a through-channel 60, which extends from the free end 62 of the sleeve 40 up to an outlet opening 64 of the air envelope part 14. The outlet opening 64 is arranged on the end wall 52 of the housing 46.

As can be seen in particular in FIGS. 3 and 4, the through-channel 60 comprises a receiving portion 66, which receives the liquid jet 18 provided by the flat jet nozzle 30 and which is adjoined in the flow direction of the liquid jet 18 by a dispensing portion, which extends up to the outlet opening 64 and continuously widens in the jet plane 16 defined by the liquid jet 18 with increasing proximity to the outlet opening 64. The widening of the dispensing portion 68 ensures that the liquid jet 18 provided by the flat jet nozzle 30 is not impaired by the through-channel 60, rather, the liquid jet 18 adopts a distance from the wall of the through-channel 60 that remains substantially constant over the entire length of the dispensing portion 68.

At the height of the receiving portion 66, the side walls 56, 58 of the housing 46 each have an air intake opening 70 and 72, which are each adjoined by an air intake channel 74 and 76 directed into the interior of the housing 46.

Within the receiving portion 66, a negative pressure is formed under the effect of the liquid jet 18, such that air is drawn into the receiving portion 66 via the air intake openings 70, 72 and the adjoining air intake channels 74, 76, the air surrounding the liquid jet 18 in the circumferential direction in the form of an air jacket and being discharged together with the liquid jet 18 via the outlet opening 64.

The liquid jet discharged from the dispensing device 10 is thus surrounded by an air flow in the shape of a jacket, which reduces the interaction of the liquid jet 18 with the ambient air, such that the deceleration of the liquid jet 18 can be reduced and the compactness of the liquid jet 18 is less affected by the ambient air.

The dispensing portion 68 and an end region of the receiving portion 66 arranged directly upstream of the dispensing portion 68 is defined by a pipe piece 78, which is surrounded by the housing 46 and is held on the top wall 48 and the base wall 50 of the housing 46 by means of holding members 80.

The side walls 56, 58 of the housing 46 extend from the end wall 52 to the rear wall 54. At a small distance from the end wall 52, the side walls 56, 58 each have a first holding rib 82, which engages through a complementarily formed holding slot 84 of the top wall 58 in a positive-locking manner. In addition, the side walls 56, 58 at a small distance from the end wall 52 each have a second holding rib not shown in the drawing for achieving a better overview, which engages through a complementary formed holding slot of the base wall 50 in a positive-locking manner.

The air intake openings 70, 72 of the side walls 56, 58 are adjoined in the direction toward the jet producing part 12 in each case by one of the aforementioned latching hooks 42 and 44, respectively. The latching hooks 42, 44 each engage behind a latching projection 86, 88 arranged on the inner side of the half-shells 34, 36 of the housing shell 32 of the jet producing part 12, such that the air envelope part 14 is latchable to the jet producing part 12. In order to release the latching connection if necessary and to separate the air envelope part 14 from the jet producing part 12, the latching hooks 42, 44, in a side wall region adjoining the air intake openings 70, 72 in the direction toward the end wall 52, each comprise a release element 90, 92, which is configured in the form of a material thickening of the respective side wall 56, 58 and projects outwardly from the respective side wall 56, 58. This is made clear in FIG. 4, for example.

As already mentioned, the air envelope part 14 is pluggably connectable and releasably latchable to the jet producing part 12. To establish the plug connection, the sleeve 40 of the air envelope part 14 can be plugged into the housing shell 32 of the jet producing part 12 and can be latched to the housing shell 32 by means of the latching projections 86, 88. When plugging the sleeve 40 into the housing shell 32, the latching hooks 42, 44 automatically assume their latching position in which they engage behind the respective associated latching projection 86, 88. If the user wishes to separate the air envelope part 14 from the jet producing part 12 again, they must only press the release elements 90, 92 against one another to achieve this. This has the consequence that the side walls 56, 58 and with these also the latching hooks 42, 44 are moved into a release position in which they release the respective latching projection 86, 88.

As already mentioned, the dispensing portion 68 widens in the jet plane 16 of the liquid jet 18 with increasing proximity to the outlet opening 64. The dispensing portion 68 has an opening angle α of 25°. The flat jet nozzle 30 has a nozzle contour and nozzle exit opening, which are configured in such a way that the liquid is formed into a fan-shaped jet pattern upon leaving the flat jet nozzle 30, wherein the jet angle β in the exemplary embodiment depicted is also 25°.

As can be seen from FIGS. 3 and 4, the flow cross-section of the end region of the receiving portion 66 immediately upstream of the dispensing portion 68 decreases continuously in the direction of the dispensing portion 68, wherein the smallest flow cross-section of the receiving portion 66 in the embodiment depicted is arranged at a distance a of 29 mm. The smallest flow cross-section of the receiving portion 66 is adjoined by the dispensing portion 68 with a continuous tangent.

The dispensing device 10 is set up to dispense liquid at a pressure of 70 bar to 250 bar, wherein the volume flow of the liquid is about 300 l/h to about 1,800 l/h. The height of the dispensing portion 68 perpendicular to the jet plane 16 is about 6 mm in the region of the dispensing portion 68 directly adjoining the receiving portion 66 and decreases to a value of about 2 mm in the end region of the dispensing portion 68, which is arranged directly upstream of the outlet opening 64.

In the embodiment depicted, the outlet opening 64 has a width B of 80 mm in the jet plane 16, wherein the outlet opening of the air envelope part 14 in the embodiment depicted is arranged at a distance A of 17 cm from the nozzle exit opening of the flat jet nozzle 30.

The liquid jet 18 widening in the shape of a fan can be directed at a surface to clean the surface. If the liquid jet 18 is directed perpendicularly to the surface to be cleaned and moved in a uniform manner relative to the surface perpendicular to the jet plane, a strip-shaped surface region is formed, which has been cleaned with a certain cleaning intensity and the width of which is presently referred to as the cleaning width. The use of the air envelope part 14 hereby increases the cleaning width compared to the cleaning width that can be achieved at the same cleaning intensity by means of the flat jet nozzle 30 alone without the air envelope part 14. It has been recognized that a concrete linear relationship exists between a predetermined percentage increase in the cleaning width and the distance A of the outlet opening 64 of the air envelope part 14 from the nozzle exit opening of the flat jet nozzle 30 required for this increase. The distance A of the outlet opening 64 of the air envelope part 14 from the nozzle exit opening of the flat jet nozzle 30 required for the desired percentage increase in the cleaning width measured in centimeters is namely at least 0.16 times the desired percentage increase in the cleaning width plus a fixed value of 9 cm.

In order to verify the above-mentioned linear relationship between the percentage increase in the cleaning width and the distance required for this increase, measurements were carried out with a plurality of dispensing devices, which differed from the above-described dispensing device 10 only by different distances A, the distances A being between 12.8 cm and 21.3 cm, depending on the dispensing device. For the measurements, in each case a white plastic sheet made of extruded polystyrene was coated with black dispersion paint. In a first step, after curing of the dispersion paint, a liquid jet widening in the shape of a fan was directed vertically from above onto the surface of the plastic plate coated with dispersion paint using the flat jet nozzle 30 alone without the use of the air envelope part 14, wherein the plastic plate was moved perpendicular to the jet plane 16 at a constant speed of 10 cm/s, so that a strip-shaped surface region was formed on the plastic plate, in which the dispersion paint was partially removed. The distance of the nozzle exit opening of the flat jet nozzle 30 from the plastic plate was set so that the dispersion paint was removed to about 50%. This was the case at a distance of 13.5 cm. The removal led to a lightening of the plastic plate in the form of a certain gray value, which indicates how light the surface strip appears to the human eye. The width of the lightened surface region represents the cleaning width achieved by means of the flat jet nozzle 30 without the use of the air envelope part 14 at a cleaning intensity that corresponds to the detected lightening (gray value) of the surface region. The lightening thus provides a measure of the cleaning intensity achieved.

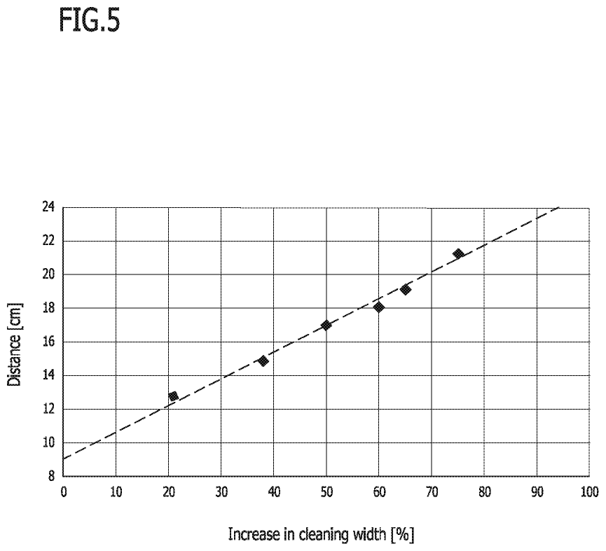

In a further step, the dispensing devices, which differ from one another only in the distance A, were then positioned one after the other above the plastic plate coated with dispersion paint. In turn, the liquid jet 18 widening in the shape of a fan in the jet plane 16 that exits the respective dispensing device is directed perpendicularly from above onto the plastic plate while said plastic plate was moved perpendicularly to the jet plane 16 at a constant speed of 10 cm/s relative to the dispensing device. Due to the action of the liquid jet 18, a strip-shaped lightened surface region was created on the plastic plate. The distance of the outlet opening of the dispensing devices from the plastic plate has been set individually for each dispensing device such the same lightening and thus the same cleaning intensity was achieved as when using the flat jet nozzle 30 without the air envelope part 14, the strip-shaped surface region thus had the same gray value as when using the flat jet nozzle 30 without the air envelope part 14. This was the case at distances of 1.5 cm to 3.3 cm, depending on the dispensing device. In the measurements of the different dispensing devices, the same cleaning intensity was thus present as in the measurement with the flat jet nozzle 30 alone without the air envelope part 14. The pressure of the liquid provided to the jet producing part 12 was 126 bar in all measurements, the volume flow of the liquid was 490 l/h. The cleaning widths achieved with the individual dispensing devices were each measured and compared with the cleaning width that was achieved when using the flat jet nozzle 30 without the air envelope part 14 at the same cleaning intensity. The result of the measurements is shown in FIG. 5 in the form of a graph. The graph shows the respective distance A of the measured dispensing devices, i.e., the distance of the outlet opening 64 of the air envelope part 14 from the nozzle exit opening of the flat jet nozzle 30, as a function of the respectively measured percentage increase in the cleaning width achieved in each case by means of the dispensing devices compared with the cleaning width that was achieved at the same cleaning intensity with the flat jet nozzle 30 without the air envelope part 14. The graph shows that the distance of the outlet opening 64 of the air envelope part 14 from the nozzle exit opening of the flat jet nozzle 30 required for a predetermined percentage increase in the cleaning width is at least 0.16 times the predetermined percentage increase in the cleaning width plus a fixed value of 9 cm. Thus, if a predetermined percentage increase in the cleaning width is to be achieved by means of the dispensing device 10 in accordance with the invention compared to the cleaning width that can be achieved at the same cleaning intensity with the flat jet nozzle 30 without the air envelope part 14, it is only necessary to configure the dispensing device 10 in such a way that the distance A between the outlet opening 64 of the air envelope part 14 and the nozzle exit opening of the flat jet nozzle 30 meets the above-mentioned condition. This applies at least to increases in the cleaning width in the range of 20% to 75%.

1. A dispensing device for dispensing a liquid jet that is surrounded by an air flow in the form of a jacket and widens in the shape of a fan in a jet plane, wherein the dispensing device comprises a jet producing part having a flat jet nozzle for producing the liquid jet and comprises an air envelope part for enveloping the liquid jet with an air flow, wherein the air envelope part comprises a through-channel, which comprises a receiving portion for receiving the liquid jet and a dispensing portion for dispensing the liquid jet and the air flow enveloping it, wherein the receiving portion is in flow connection with at least one air intake opening of the dispensing device and the dispensing portion extends up to an outlet opening and widens in the shape of a fan in the jet plane, wherein the distance of the outlet opening of the air envelope part from the nozzle exit opening of the flat jet nozzle measured in centimeters is at least 0.16 times a predetermined percentage increase in the cleaning width plus a fixed value of 9 cm, wherein the percentage increase in the cleaning width refers to the cleaning width that is achievable at the same cleaning intensity with the flat jet nozzle without the air envelope part.

2. The dispensing device in accordance with claim 1, wherein the predetermined percentage increase in the cleaning width is 20% to 75%.

3. The dispensing device in accordance with claim 1, wherein the distance of the outlet opening of the air envelope part from the nozzle exit opening of the flat jet nozzle measured in centimeters is at most 0.16 times the predetermined percentage increase in the cleaning width plus a further fixed value of at most 13.5 cm, in particular 11 cm.

4. The dispensing device in accordance with claim 1, wherein the dispensing portion that widens in the shape of a fan in the jet plane has an opening angle of 20° to 30° in the jet plane.

5. The dispensing device in accordance with claim 4, wherein the dispensing portion has an opening angle of 25° in the jet plane.

6. The dispensing device in accordance with claim 1, wherein the dispensing device is set up to dispense liquid at a pressure of 10 bar to 300 bar.

7. The dispensing device in accordance with claim 1, wherein the dispensing device is set up to dispense liquid with a volume flow of 300 l/h to 3,000 l/h.

8. The dispensing device in accordance with claim 1, wherein the flow cross-section of the receiving portion decreases in the direction of the dispensing portion.

9. The dispensing device in accordance with claim 8, wherein the dispensing portion directly adjoins the smallest flow cross-section of the receiving portion in the flow direction of the liquid.

10. The dispensing device in accordance with claim 9, wherein the dispensing portion adjoins the receiving portion with a continuous tangent.

11. The dispensing device in accordance with claim 9, wherein the smallest flow cross-section of the receiving portion is arranged at a distance of 3 mm to 70 mm from the nozzle exit opening of the flat jet nozzle.

12. The dispensing device in accordance with claim 1, wherein the height of the dispensing portion perpendicular to the jet plane is 1 mm to 6 mm.

13. The dispensing device in accordance with claim 1, wherein the height of the dispensing portion perpendicular to the jet plane is constant over the entire length of the dispensing portion or decreases at least in a longitudinal region of the dispensing portion with increasing proximity to the outlet opening of the air envelope part.

14. The dispensing device in accordance with claim 1, wherein the width of the outlet opening of the air envelope part in the jet plane is 60 mm to 120 mm.

15. The dispensing device in accordance with claim 1, wherein the flat jet nozzle is set up to dispense a liquid jet that widens in the shape of a fan at a jet angle of 20° to 30°.
